(19) United States
(12) Patent Application Publication
(10) Pub. No.: US 2005/0105992 A1
(43) Pub. Date: May 19, 2005

(54) Apparatus of stocking substrates

(76) Inventors: Geun-Soo An, Cheonan-si (KR); Gi-Cheon Yoon, Sungnam-si (KR)

Correspondence Address: CANTOR COLBURN, LLP, 55 GRIFFIN ROAD SOUTH, BLOOMFIELD, CT, 06002, US

(21) Appl. No.: 10/960,869

(22) Filed: Oct. 7, 2004

(30) Foreign Application Priority Data
Oct. 21, 2003 (KR) 10-2003-0073361

(51) Int. Cl. B65G 1/00

(52) U.S. Cl. 414/280

(57) ABSTRACT

A substrate stocking apparatus is provided, which includes: a plurality of stockers, each stocker including a plurality of shelf plates that includes a plurality of supporting pins supporting the substrate and a plurality of vertical frames fixing and connecting the shelf plates; and an indexer taking a substrate into and out of the stockers.

### BACKGROUND OF THE INVENTION

(a) Field of the Invention

The present invention relates to an apparatus of stocking substrates.

(b) Description of the Related Art

Generally, a semiconductor substrate used for a semiconductor device or a glass substrate for a flat panel display such as a liquid crystal display (LCD) and an organic light emitting display (OLED) is transferred by a conveyor system during the fabrication of the semiconductor device or the display panel. The conveyor system includes a conveyor mounting the substrate, a driving roller moving the conveyor, and a driving motor for driving the driving roller.

An LCD generally includes two panels made of glass substrates and a liquid crystal layer, while an OLED includes a signal panel made of glass substrates. The LCD displays images by applying voltages to field-generating electrodes disposed on the panels to generate electric fields, which determine the orientations of liquid crystal molecules in the liquid crystal layer. The OLED displays images by applying currents or voltages to light emitting diodes that emits light depending on the currents or voltages.

A conventional substrate stocking apparatus for LCDs transfers glass substrates to several process equipments using cassettes, stockers, and indexers. Several substrates are received in cassettes, and the cassettes containing the substrates are stocked in a stocker. The substrates are taken out of the cassette by a robot indexer and brought into process equipments.

However, the conventional substrate stocking apparatus may have several problems as the as the glass substrates becomes large, for example, the glass substrates are larger than about 1500 mm.

First, the large substrates stored in the cassette are apt to get drooping due to its heavy weight. In addition, heavier substrates require larger robot arms of indexers, and thus the pitch of horizontal shelves of a cassette gets large to increase the cassette and the stocker. The large and heavy substrates may also cause problems in other devices such as a cassette crane, a cassette conveyor, and a lifer for handing the cassettes.

### SUMMARY OF THE INVENTION

A motivation of the present invention is to solve the problems of the conventional art.

A substrate stocking apparatus is provided, which includes: a plurality of stockers, each stocker including a plurality of shelf plates that includes a plurality of supporting pins supporting the substrate and a plurality of vertical frames fixing and connecting the shelf plates; and an indexer taking a substrate into and out of the stockers.

The indexer may include a robot arm for holding the substrate, which may be four-forked.

The indexer may further include a movement adjusting unit for moving the robot arm, and the movement adjusting unit may include a horizontal movement adjuster, a vertical movement adjuster, and a rotator.

The apparatus may further include a conveyor transferring the substrate from either of one of the stockers and the indexer to an external device or from the external device to either of one of the stockers and the indexer.

A substrate stocking apparatus is provided, which includes: a first array of stockers; a first indexer taking a substrate into and out of the stockers; and a first conveyor transferring a substrate from one of the first indexer and the first array of stockers to an external device or from the external device to the one of the first indexer and the first array of stockers.

According to an embodiment of the present invention, the first conveyor is disposed opposite the first array of stockers with respect to the first indexer and it transfers a substrate from the first indexer to an external device or from the external device to the first indexer. In this case, the apparatus may further include: a second indexer that is disposed opposite the first indexer with respect to the first array of stockers and take substrates into and out of the stockers; and a second conveyor that is disposed opposite the first array of stockers with respect to the second indexer and transfers a substrate from the second indexer to an external device or from the external device to the second indexer.

According to an embodiment of the present invention, a) the first array of stockers comprises a first entrance stocker, b) the first conveyor is disposed opposite the first indexer with respect to the first array of stockers, coupled to the first entrance stocker, and transfers a substrate from the first entrance stocker to an external device or from the external device to the first entrance stocker, and c) the first indexer moves a substrate between the first entrance stocker and another stocker in the first array of stockers. In this case, the apparatus may further include: a second array of stockers that is disposed opposite the first array of stockers with respect to the first indexer and includes a second entrance stocker; and a second conveyor that is disposed opposite the first indexer with respect to the second array of stockers and transfers a substrate from the second entrance stocker to an external device or from the external device to the second entrance stocker.

The first indexer moves a substrate between the first or the second entrance stocker and another stocker in the first and the second arrays of stockers.

Alternatively, the apparatus may further include: a third array of stockers that is disposed between the first indexer and the second array of stockers; and a second indexer that is disposed between the second array of stockers and the third array of stockers and moves a substrate between the second entrance stocker and another stocker in the second and the third arrays of stockers, wherein the first indexer moves a substrate between the first entrance stocker and another stocker in the first and the third arrays of stockers.

Each of the stockers may include a plurality of shelf plates including a plurality of supporting pins thereon that contacting a substrate and a plurality of vertical frames fixing and connecting the shelf plates.

Each of the indexers may include a forked robot arm for holding a substrate. Each of the indexers may further include a horizontal movement adjuster that moves the robot arm in a horizontal direction, a vertical movement adjuster that moves the robot arm in a vertical direction, and a rotator that rotates the robot arm.

### BRIEF DESCRIPTION OF THE DRAWINGS

The present invention will become more apparent by describing embodiments thereof in detail with reference to the accompanying drawings in which:

FIG. 1 is a perspective view of an apparatus of stocking substrates according to an embodiment of the present invention;

FIG. 2 is a top view of the substrate stocking apparatus shown in FIG. 1, FIG. 3 is a sectional view of the substrate stocking apparatus shown in FIG. 2 taken along the line III-III′;

FIG. 4 is an expanded top view of a robot arm and supporting pins of the substrate stocking apparatus shown in FIGS. 1-3; and FIG. 5 is a sectional view of the substrate stocking apparatus shown in FIG. 4 taken along the line V-V′;

FIG. 6 is a perspective view of an apparatus of stocking substrates according to another embodiment of the present invention; and

FIG. 7 is a perspective view of an apparatus of stocking substrates according to another embodiment of the present invention.

### DETAILED DESCRITPION OF THE PREFERRED EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, like numerals refer to like elements throughout.

Now, apparatus of stocking glass substrates according to embodiments of the present invention will be described with reference to the accompanying drawings.

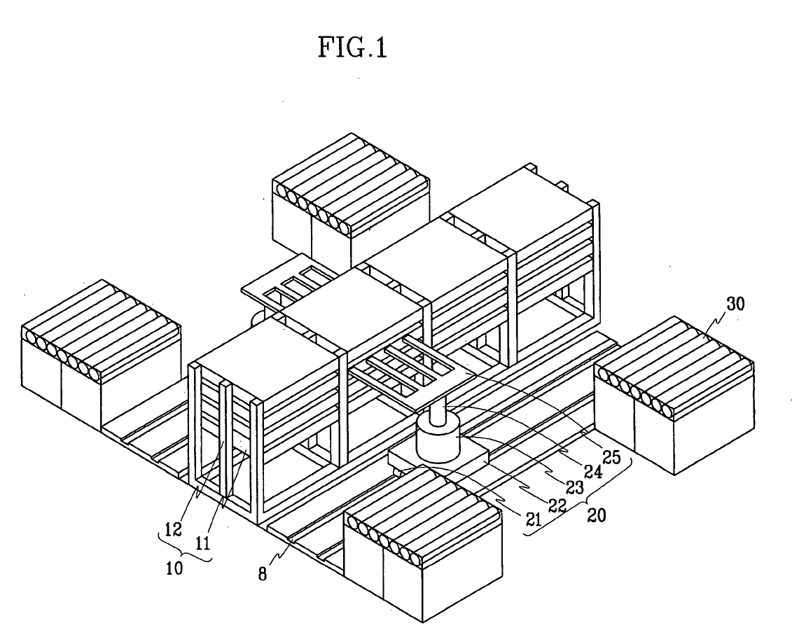

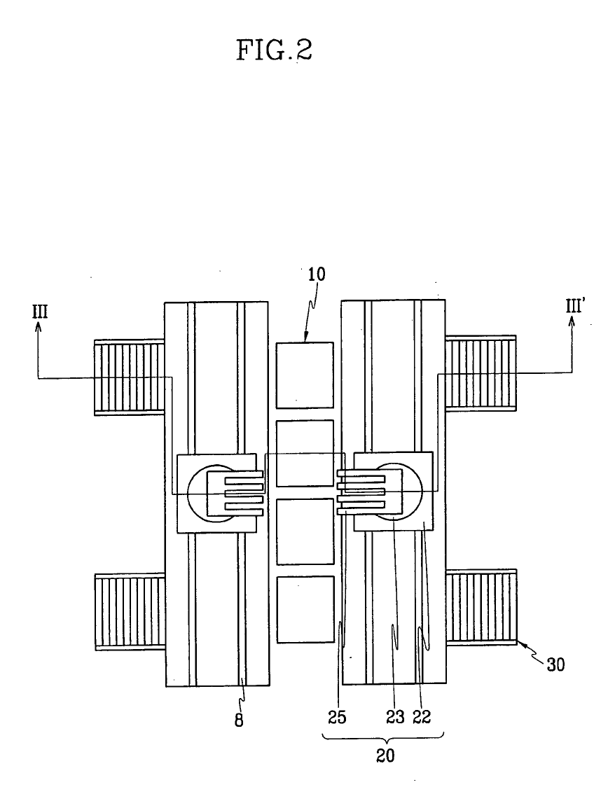

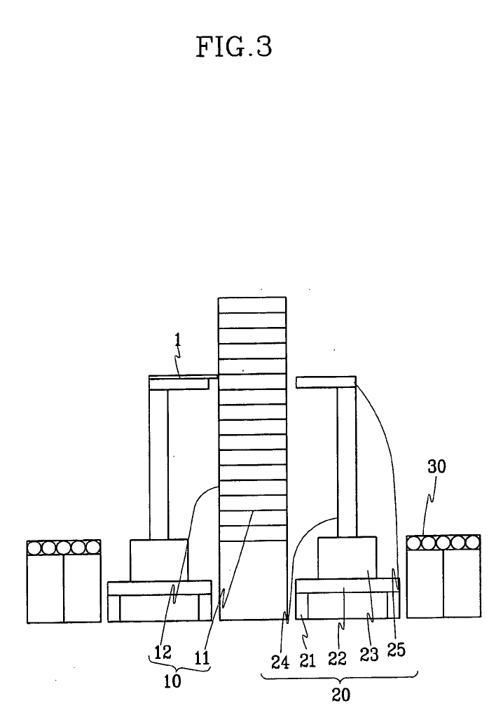

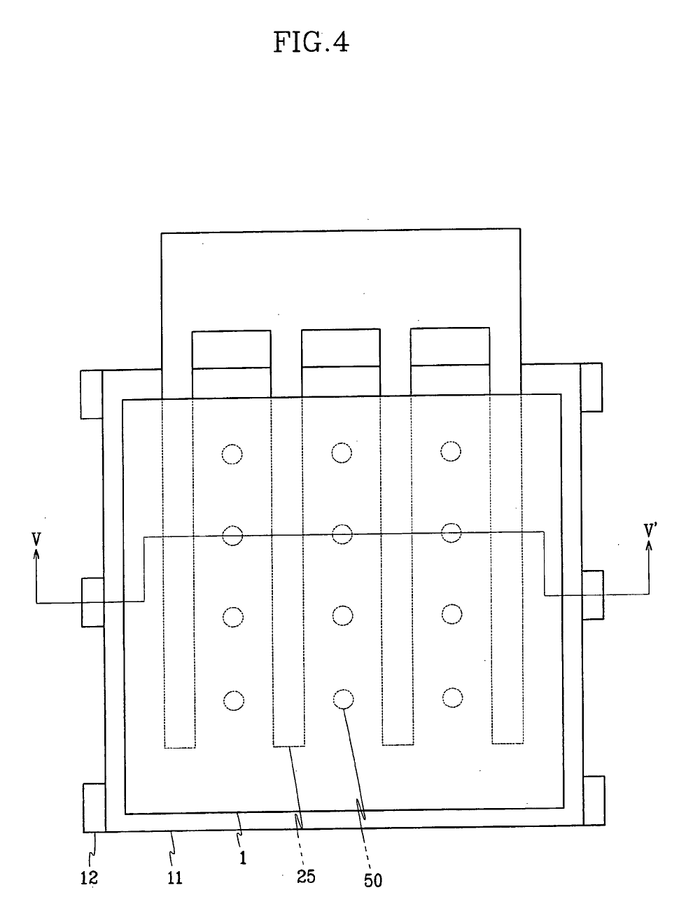

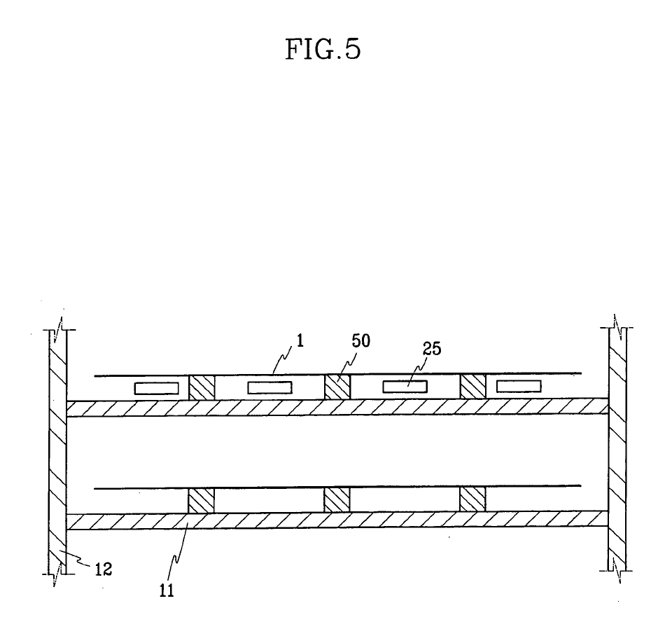

FIG. 1 is a perspective view of an apparatus of stocking substrates according to an embodiment of the present invention, FIG. 2 is a top view of the substrate stocking apparatus shown in FIG. 1, FIG. 3 is a sectional view of the substrate stocking apparatus shown in FIG. 2 taken along the line III-III′, FIG. 4 is an expanded top view of a robot arm and supporting pins of the substrate stocking apparatus shown in FIGS. 1-3, and FIG. 5 is a sectional view of the substrate stocking apparatus shown in FIG. 4 taken along the line V-V′.

Referring to FIGS. 1-3, a substrate stocking apparatus according to this embodiment includes an array of stockers 10 arranged in a line, a pair of indexers 20 provided at both side of the array of stockers 10, and a plurality of conveyors 30 disposed opposite the stockers 10 with respect to the array of stockers 10.

Each of the stockers 10 includes a plurality of shelf plates 11 and a plurality of vertical frames 12. The shelf plates 11 are vertically arranged and spaced apart from each other, and the vertical frames 12 are combined with the shelf plates 11 and fix the shelf plates 11.

Referring to FIGS. 4 and 5, each shelf plate 11 includes a plurality of supporting pins 50 arranged thereon in rows and columns for supporting a substrate 1.

The indexers 20 bring in the substrates 1 in the stockers 10 and take out the substrates 1 from the stockers 10. The number of the indexers 20 disposed at each side may be two or more.

Each indexer 20 includes a robot arm 25, a horizontal movement adjuster 21-23, and a vertical movement adjuster 24.

A robot arm 25 contacts and carries the substrate 1. The robot arm 25 is four-forked for preventing the substrate 1 from drooping, particularly for a large substrate. FIGS. 4 and 5 show that each finger of the four-forked robot arm 25 is disposed between the supporting pins 50 and supports a bottom surface of the substrate 1.

The horizontal movement adjuster 21-23 adjusts the horizontal movement of the robot arm 25 and includes a plurality of moving wheels (or rollers) 21, a supporting plate 22, and a rotator 23.

The moving wheels 21 are provided under the supporting plate 22 and they moves along a plurality of guiding grooves 8 provided thereunder and extending parallel to each other.

The rotator 23 is provided on the supporting plate 22 for rotating the robot arm 25.

The vertical movement adjuster 24 adjusts the vertical movement of the robot arm 25.

Accordingly, the indexer 20 can move the substrate 1 both of the horizontal direction and the vertical direction.

Referring to FIGS. 1-3, each conveyor 30 transfers the substrate 1 from an external device (not shown) to the indexer 20 or from the indexer 20 to the external device.

The substrate stocking apparatus may include a reader (not shown) for reading an information code provided at the substrate 1, thereby managing data of the substrate 1. The reader may be provided at the conveyors 30, the indexers 20, or the stockers 10.

Now, an operation of the substrate stocking apparatus will be described in detail.

First, bringing a substrate into a stocker is described.

A substrate 1 to be stocked at a stocker 10 is transferred by a conveyor 30 from an external process device (not shown), and an indexer 20 approaches the conveyor 30 using its horizontal movement adjuster 21-23.

In front of the conveyor 30, the indexer 20 protrudes its robot arm 25 below the substrate 1, contacts the robot arm 25 with the substrate 1 using its vertical movement adjuster 24, and the indexer 20 holds up the substrate 1 using the vertical movement adjuster 24. The indexer 20 turns round using its rotator 23 and moves to the stocker 10 using the horizontal movement adjuster 21-23.

In front of the stocker 10, the indexer 20 protrudes the robot arm 25 carrying the substrate 1 and puts down the substrate 1 on a shelf plate 11 of the stocker 10. The supporting pins 50 of the shelf plate 11 prevent the substrate 1 from getting bent.

Taking a substrate out of a stocker is performed in a reverse manner to brining a substrate into a stocker.

In detail, an indexer 20 moves to a stocker 10 that mounts a substrate 1 to be taken out. The indexer 20 takes out the substrate 1 from the stocker 10 using its robot arm 25 and moves to a conveyor 30 to carry the substrate 1. The indexer 20 puts down the substrate 1 on the conveyor 30.

This stocking apparatus manages taking out, brining in, and keeping of substrates one by one and prevents the droop of substrates by providing the above-described stockers and robot arms.

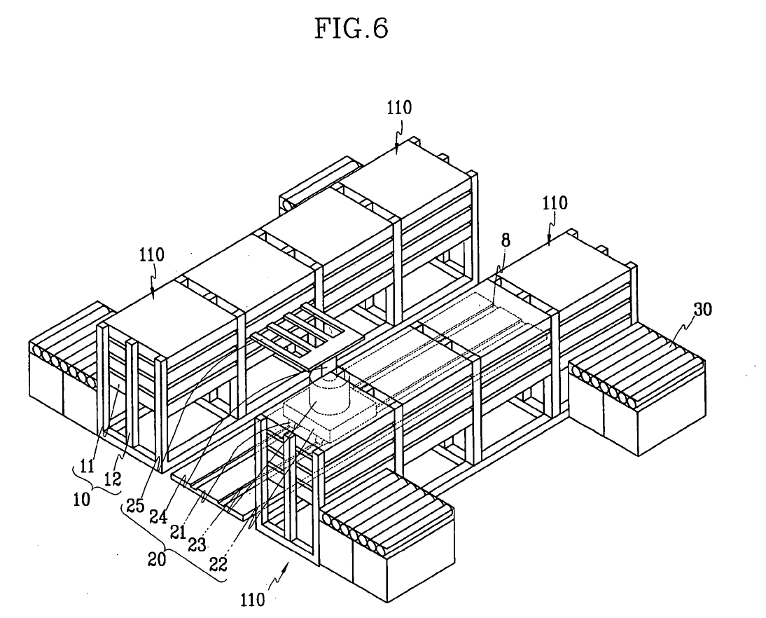

An apparatus of stocking substrates according to another embodiment of the present invention is described in detail with reference to FIG. 6, which is a perspective view of the substrate stocking apparatus.

Referring to FIG. 6, a substrate stocking apparatus according to this embodiment includes a pair of arrays of stockers 10 arranged in parallel, an indexer 20 disposed between the arrays of stockers 10, and a plurality of conveyors 30 disposed opposite the indexer 20 with respect to the stockers 10.

The stockers 10 includes a plurality of entrance stockers 110 coupled to respective conveyors 30 in a manner that a shelf plate 11, for example, a bottom shelf plate 11 of an entrance stocker 10 adjacent to an conveyor 30 is directly connected to the conveyor 30.

When brining a substrate 1 into the stockers 10, the substrate 1 is brought into an entrance stocker 10, which is coupled to a conveyor 30, by the conveyor 30 and transferred to another stocker 10 by the indexer 20.

When taking out a substrate 1 from the stokers 10, the substrate 1 in a stocker 10 is carried to an entrance stocker 10, which is coupled to a conveyor 30, by the indexer 20 and then transferred to the conveyor 30.

The stocking apparatus may include one or more additional indexers.

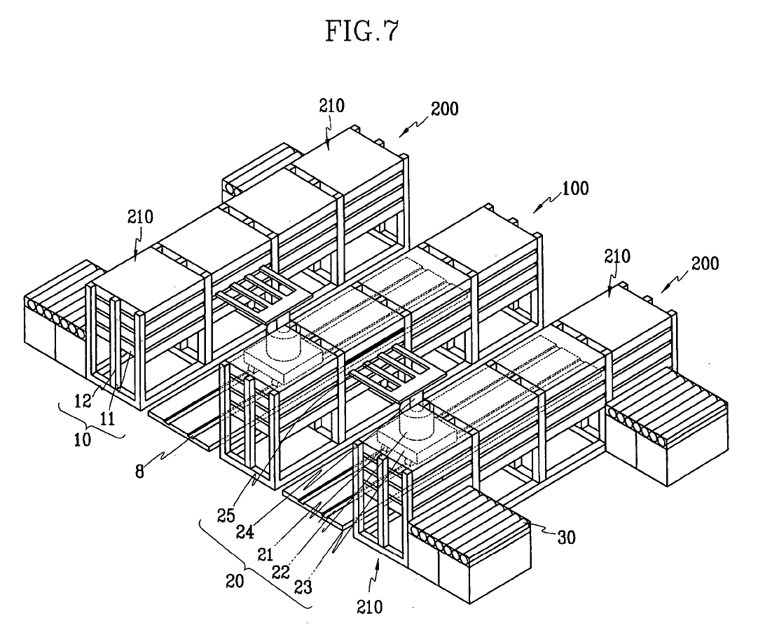

An apparatus of stocking substrates according to another embodiment of the present invention is described in detail with reference to FIG. 7, which is a perspective view of the substrate stocking apparatus.

Referring to FIG. 7, a substrate stocking apparatus according to this embodiment includes three arrays, i.e., a center array 100 and two outer arrays 200 of stockers 10 arranged in parallel, a pair of indexers 20 disposed between the center array 100 and the outer arrays 200, and a plurality of conveyors 30 disposed opposite the indexers 20 with respect to the outer arrays 200.

Like the stocking apparatus shown in FIG. 6, the stockers 10 in the outer arrays 200 includes a plurality of entrance stockers 210 coupled to respective conveyors 30 in a manner that a shelf plate 11, for example, a bottom shelf plate 11 of an entrance stocker 210 adjacent to a conveyor 30 is directly connected to the conveyor 30.

When brining a substrate 1 into the stockers 10, the substrate 1 is brought into an entrance stocker 210, which is coupled to a conveyor 30, by the conveyor 30 and transferred to another stocker 10 by an indexer 20.

When taking out a substrate 1 from the stokers 10, the substrate 1 in a stocker 10 is carried to an entrance stocker 210, which is coupled to a conveyor 30, by an indexer 20 and then transferred to the conveyor 30.

The number of the arrays of stockers may be larger than four if the number of substrates to be stocked or it is required by a manufacturing process.

As described above, the substrate stocking apparatus according to the above-described embodiments stocks substrates directly in a stocker.

Therefore, no cassette for storing substrates is required and there is no problem in the increase of a cassette crane, a cassette conveyor, and a lifer for handing the cassettes.

Moreover, the substrate stocking apparatus is suitable for in-line transferring of the substrates, and it can receive more substrates in comparison with a conventional one that receives cassettes storing the substrates.

In addition, the supporting pins prevent the substrates from getting drooping.

While the present invention has been described in detail with reference to the preferred embodiments, those skilled in the art will appreciate that various modifications and substitutions can be made thereto without departing from the spirit and scope of the present invention as set forth in the appended claims.

1. A substrate stocking apparatus comprising:
a plurality of stockers, each stocker including a plurality of shelf plates that includes a plurality of supporting pins supporting the substrate and a plurality of vertical frames fixing and connecting the shelf plates; and
an indexer taking a substrate into and out of the stockers.

2. The apparatus of claim 1, wherein the indexer comprises a robot arm for holding the substrate.

3. The apparatus of claim 2, wherein the robot arm are forked.

4. The apparatus of claim 3, wherein the robot arm comprises four fingers.

5. The apparatus of claim 2, wherein the indexer further comprises a movement adjusting unit for moving the robot arm.

6. The apparatus of claim 5, wherein the movement adjusting unit comprises a horizontal movement adjuster and a vertical movement adjuster.

7. The apparatus of claim 6, wherein the horizontal movement adjuster comprises a rotator for rotating the robot arm.

8. The apparatus of claim 1, further comprising a conveyor transferring the substrate from either of one of the stockers and the indexer to an external device or from the external device to either of one of the stockers and the indexer.

9. A substrate stocking apparatus comprising:
a first array of stockers;
a first indexer taking a substrate into and out of the stockers; and
a first conveyor transferring a substrate from one of the first indexer and the first array of stockers to an external device or from the external device to the one of the first indexer and the first array of stockers.

10. The apparatus of claim 9, wherein the first conveyor is disposed opposite the first array of stockers with respect to the first indexer and transfers a substrate from the first indexer to an external device or from the external device to the first indexer.

11. The apparatus of claim 10, further comprising:
a second indexer that is disposed opposite the first indexer with respect to the first array of stockers and take substrates into and out of the stockers; and
a second conveyor that is disposed opposite the first array of stockers with respect to the second indexer and transfers a substrate from the second indexer to an external device or from the external device to the second indexer.

12. The apparatus of claim 11, wherein each of the stockers comprises a plurality of shelf plates including a plurality of supporting pins thereon that contacting a substrate and a plurality of vertical frames fixing and connecting the shelf plates.

13. The apparatus of claim 11, wherein each of the first and the second indexers comprises a forked robot arm for holding a substrate.

14. The apparatus of claim 13, wherein each of the first and the second indexers further comprises a horizontal movement adjuster that moves the robot arm in a horizontal direction and includes a rotator, and a vertical movement adjuster that moves the robot arm in a vertical direction.

15. The apparatus of claim 9, wherein a) the first array of stockers comprises a first entrance stocker, b) the first conveyor is disposed opposite the first indexer with respect to the first array of stockers, coupled to the first entrance stocker, and transfers a substrate from the first entrance stocker to an external device or from the external device to the first entrance stocker, and c) the first indexer moves a substrate between the first entrance stocker and another stocker in the first array of stockers.

16. The apparatus of claim 15, further comprising:
a second array of stockers that is disposed opposite the first array of stockers with respect to the first indexer and includes a second entrance stocker; and
a second conveyor that is disposed opposite the first indexer with respect to the second array of stockers and transfers a substrate from the second entrance stocker to an external device or from the external device to the second entrance stocker.

17. The apparatus of claim 16, wherein the first indexer moves a substrate between the first or the second entrance stocker and another stocker in the first and the second arrays of stockers.

18. The apparatus of claim 17, wherein each of the stockers comprises a plurality of shelf plates including a plurality of supporting pins thereon that contacting a substrate and a plurality of vertical frames fixing and connecting the shelf plates.

19. The apparatus of claim 18, wherein the first indexer comprises a forked robot arm for holding a substrate.

20. The apparatus of claim 16, further comprising:
a third array of stockers that is disposed between the first indexer and the second array of stockers; and
a second indexer that is disposed between the second array of stockers and the third array of stockers and moves a substrate between the second entrance stocker and another stocker in the second and the third arrays of stockers,
wherein the first indexer moves a substrate between the first entrance stocker and another stocker in the first and the third arrays of stockers.
